(19) United States
(12) Patent Application Publication
(10) Pub. No.: US 2025/0102065 A1
(43) Pub. Date: Mar. 27, 2025

(54) LUBRICANT SEAL PERFORMANCE SENSOR

(71) Applicant: SEALSENSE LIMITED, Northampton (GB)

(72) Inventors: Brian JOHNSON, Saltash (GB); Duncan VALENTINE, Northampton (GB); Dietmar TEISMANN, Krefeld (DE)

(73) Assignee: SEALSENSE LIMITED, Northampton (GB)

(21) Appl. No.: 18/832,343

(22) PCT Filed: Feb. 3, 2023
(86) PCT No.: PCT/IB2023/050994

§ 371 Date: Jul. 23, 2024

Related U.S. Application Data
(60) Provisional application No. 63/306,578, filed on Feb. 4, 2022.

(51) Int. Cl. F16J 15/3204; F16J 15/3296

(52) U.S. Cl. CPC F16J 15/3204; F16J 15/3296

(57) ABSTRACT

A lubricant seal includes a sensor that utilizes the principles of diffraction gratings. The sensor is molded into the rubber structure of the lubricant seal and is disposed above the main sealing lip of the lubricant seal. The sensor may have a single or multiple diffraction gratings. The sensor measures wear of the lubricant seal, misalignment of the lubricant seal relative to a rotating shaft, or both. The sensor can be used for real-time monitoring and predictive maintenance.

### CROSS-REFERENCE TO RELATED APPLICATIONS

This application claims priority to U.S. Provisional Patent Application No. 63/306,578, filed on Feb. 4, 2022, entitled, LUBRICANT SEAL PERFORMANCE SENSOR, and incorporated by reference herein in its entirety.

### FIELD OF THE DISCLOSURE

Embodiments of the present disclosure relate to lubricant seals and, more particularly, to lubricant seal performance sensor technology.

### BACKGROUND

Electrical and mechanical machines use bearings to support their rotors. As moving parts, the bearings are lubricated and rely on seals to avoid loss of lubricant. If the seal fails, the loss of lubricant will cause the bearing to fail. In addition to keeping the oil, grease, or other lubricants inside the bearing housing, the seal also protects against the ingress of dust and debris into the housing.

The size of lubricant seals can vary greatly, from about 13 cm to over 3 m in diameter. The global oil seal market is a multibillion dollar industry, with oil seals being used in a variety of technologies, from marine, paper, rolling mills, wind, gear drives, and Hydro technologies. Oil seals are found in systems as diverse as automobiles and wind turbines.

Whatever the application, the maintenance of an oil seal is a critical part of system integrity. Changing the bearing of a wind turbine, for example, is a very expensive task. Monitoring the seal performance is thus part of any robust maintenance system.

The global oil seal market is c. $37 bn p.a. growing at 2.1% compound annual growth rate, with 40% automotive, 60% ($22.20 billion) industrial seals, of which $13.30 billion is OEM. The market is 40% Asia; 30% Americas, 30% Europe, with the European industrial oil seal market (range 50 mm to 3 m diameter), overall $4 bn p.a. at c 3.1% CAGR, with large industrial c. $1.8 bn. There is a strong trend toward systems monitoring mainly based on bearings performance. Monitoring on large, expensive, and difficult applications has a potential market of $200 m p.a (10/15%)

It is with respect to these and other considerations that the present improvements would be useful.

### BRIEF DESCRIPTION OF THE DRAWINGS

FIGS. 1A-1D are diagrams illustrating an oil seal, in accordance with the prior art;

FIGS. 2A-2B are diagrams illustrating a lubricant seal with a sensor, in accordance with exemplary embodiments;

FIGS. 3A-3C are diagrams illustrating of a fiber Bragg grating, in accordance with the prior art;

FIG. 4 is a diagram illustrating unstrained and strained fiber Bragg gratings, in accordance with the prior art;

FIG. 5 is a diagram illustrating operation of Bragg gratings, in accordance with the prior art;

FIG. 6 is a diagram illustrating a fiber Bragg grating, as well as a graph measuring wavelength versus reflection, in accordance with the prior art; and

FIGS. 7A-7B are diagrams illustrating fiber Bragg gratings, in accordance with the prior art.

### DETAILED DESCRIPTION

Mechanical seals are used in situations where sealing is required between a rotating shaft and a vessel, such as a motor or generator housing. The seals are designed to keep fluids inside or out of the machinery, but also to allow free movement of the shaft so that machinery can operate unimpeded. The typical mechanical seal consists of three basic elements: 1) a stationary face or seat which is affixed to the wall of the vessel. This can also include an o-ring to further prevent leakage between the seal and the vessel wall; 2) a rotary face which is free to rotate and is fixed to the shaft. The rotary face can also have an o-ring between itself and the shaft to prevent this leakage path; 3) a spring, which is designed to keep the two sealing faces pushed together. The spring self-adjusts the compression as the two seal faces slowly wear away.

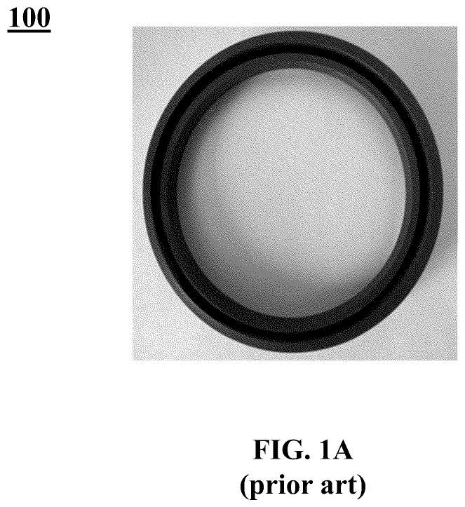

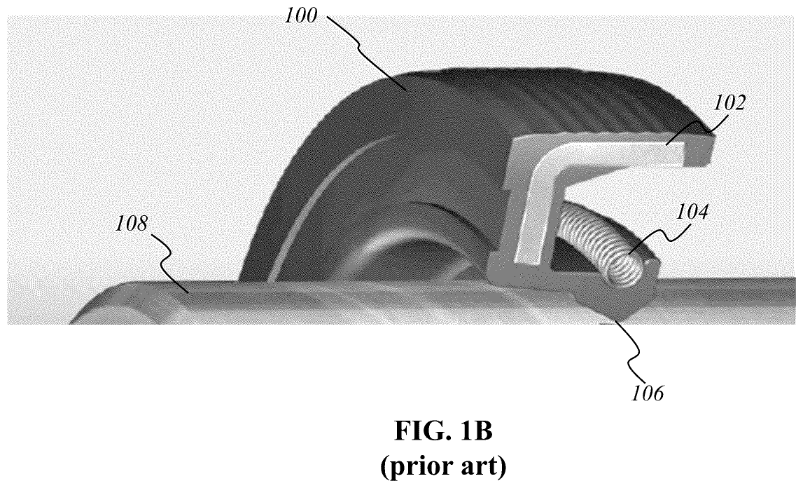

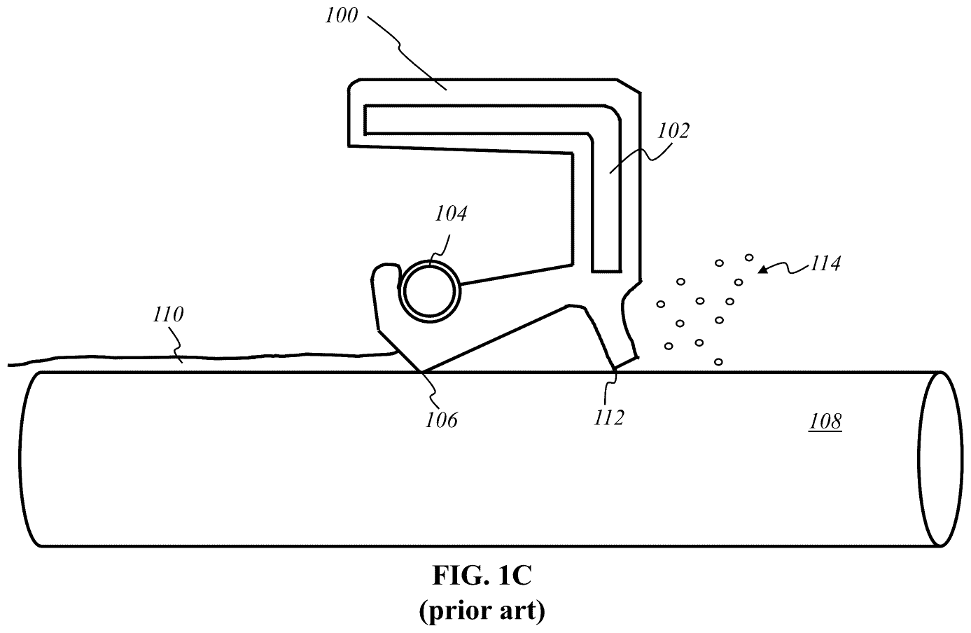

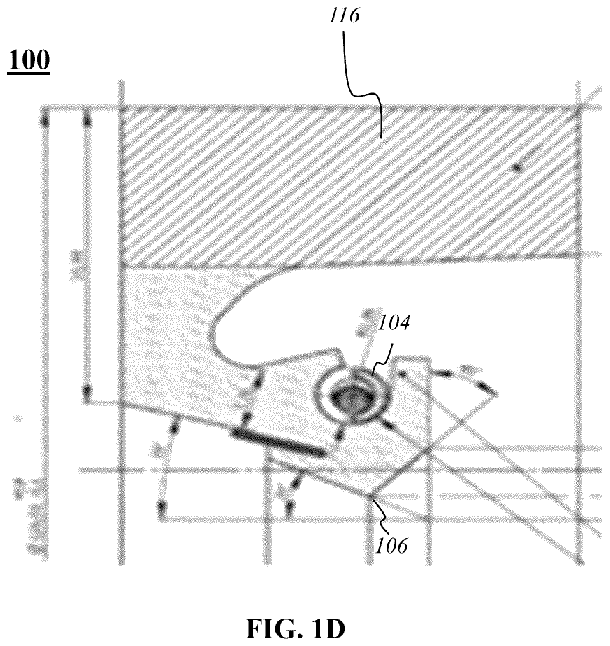

FIGS. 1A-1D are representative drawings of an oil seal, according to the prior art. FIG. 1A is a photograph of the oil seal 100; FIG. 1B is a perspective cross-sectional view of the oil seal against a shaft; FIG. 1C is a second cross-sectional view of the soil seal against the shaft; and FIG. 1D is a cross-sectional view of the oil seal. The oil seal 100 includes a metal stamping 102, a garter spring 104, a main sealing lip 106, and, optionally, a dust lip 112. Above the oil seal 100 is a stationary bore 116 (FIG. 1D). The metal stamping 102 makes the oil seal 100 more rigid. The main sealing lip 106 and the optional dust lip 112 engage with the rotating shaft 108. The oil seal 100 is disposed so that the main sealing lip is flush against a rotating shaft 108. As shown in FIG. 1C, by forming a seal between itself and the shaft 108, the oil seal 100 is designed to both keep lubricants 110, such as oil, on one side of the oil seal (interior of the machinery) and dust or debris 114 on the other side of the oil seal (exterior of the machinery).

The seal is achieved by pressing the main sealing lip 106 of the oil seal 100 to the shaft 108. The pressure of the oil seal 100 to the shaft 108 is maintained by the garter spring 104, which is embedded in the rubber material of the oil seal. The garter spring 104 thus creates a hoop stress, creating a force on the main sealing lip 106 in addition to the force provided by the cantilever of the rubber seal. The garter spring 104 thus helps to compress the oil seal 100 onto the shaft 108.

As the oil seal 100 wears down, the hoop stress in the garter spring 104 is reduced. Measuring the hoop stress of the oil seal 100 near where the rotating shaft 108 makes contact with the main sealing lip 106 provides a direct measure of the contact force. As the oil seal 100 wears, the hoop stress will be reduced, allowing seal wear to be detected. Perturbations due to misalignment of the shaft 108 or other faults will locally modulate the hoop stress, allowing these faults to be detected.

By measuring both the wear of the oil seal and the misalignment of the shaft relative to the oil seal, the costly replacement of bearings and other machinery may be avoided. As the oil seal wears, the diameter of the contact surface is reduced. This reduces the tension of the garter spring. Measuring the tension/hoop stress of the oil seal to show the rate of wear of the oil seal indicates when the oil seal requires maintenance. Misalignment of the shaft to the oil seal will cause a modulation of the hoop stress so detecting this will give an indication of other problems.

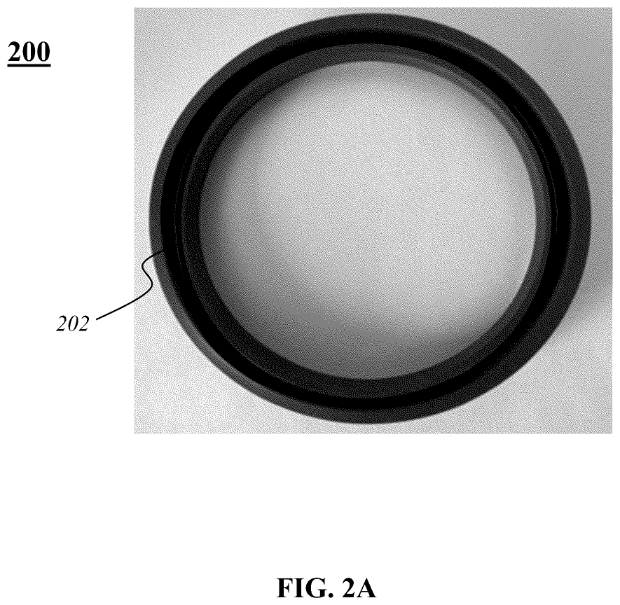

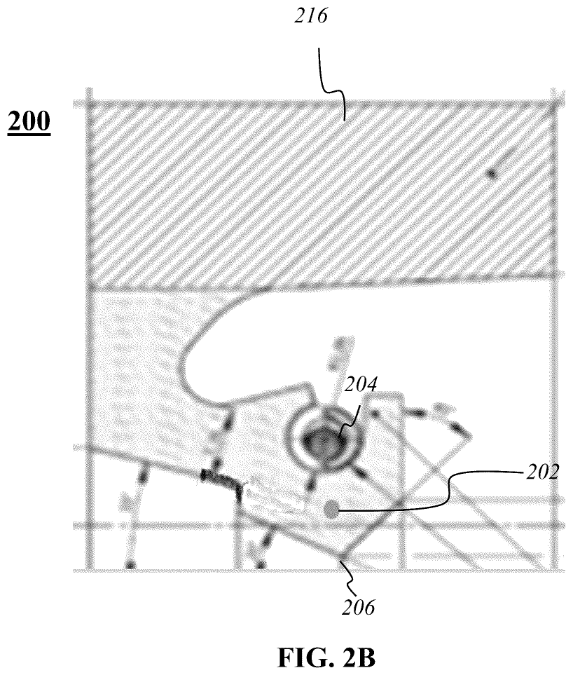

FIGS. 2A-2B are representative drawings of a lubricant seal with a sensor, according to exemplary embodiments. FIG. 2A is a photograph of the lubricant seal 200; and FIG. 2B is a cross-sectional view of the lubricant seal. The lubricant seal 200 includes many of the features of the prior art oil seal 100 (FIGS. 1A-1D), including a garter spring 204 and a main sealing lip 206, and may also optionally include a dust lip (not shown). The lubricant seal 200 features a molded fiber optic-based strain sensor 202 (known also herein as simply “sensor 202”). In exemplary embodiments, the sensor 202 is embedded within the rubber material of the lubricant seal 200 and the sensor 202 is disposed above the point of contact with the shaft, namely, above the main sealing lip 206. The sensor 202 has regions in which Bragg diffraction gratings are diffused into the fiber. The sensor 202 may thus also be called a fiber Bragg grating (FBG). Above the lubricant seal 200 is a stationary bore 216 (FIG. 2B).

FBGs are a type of distributed Bragg reflector constructed in a short segment of optical fiber that reflects particular wavelengths of light and transmits all others. This is achieved by creating a periodic variation in the refractive index of the fiber core, which generates a wavelength-specific dielectric mirror. An FBG can be used as an inline optical fiber to block certain wavelengths or it can be used as a wavelength-specific reflector. In exemplary embodiments, the sensor 202 utilizes the FBG principles to sense wear of the lubricant seal 200, misalignment of the shaft relative to the lubricant seal, or both of these conditions.

As the strain changes the dimensions of the sensor 202, a light signal supplied to the fiber can be measured which is proportional to the resulting hoop stress, indicating wear of the seal. A reflected light spectrum in the form of a Bragg wavelength will indicate the strain to the lubricant seal 200. If the lubricant seal 200 is compressed, the diffraction gratings in the sensor 202 will get closer together. If the lubricant seal 200 is stretched, the diffraction gratings in the sensor 202 will move farther apart and the spacing is effectively proportional to the wavelength of light to which the sensor 202 reacts.

In exemplary embodiments, any run-out or misalignment of the shaft will cause modulation of the signal, indicating other problems. The Bragg gratings will provide a signal which is strain under normal circumstances (a DC flat line), if measuring voltage, for instance. Run-out will stretch and/or relax the fiber of the sensor 202, making the fiber an ellipse rather than a circle, for example. This results in peaks and troughs in the strain, indicating noise. The noise on the stress would be proportional to the run-out.

As between wear of the lubricant seal 200 and misalignment of the shaft with the lubricant seal, the wear of the lubricant seal is a change in the sort of constant level, or the average level, of hoop stress. Run-out is going to be, as the shaft rotates, it pushes out on one side, stretches one side, shrinks another side. As it pushes, it strains, so that could be indicated as an AC signal which would be proportional to the rotation speed of the shaft.

In some embodiments, the sensor 202 features a single Bragg sensor. An alarm level is set to warn of impending seal failure using the sensor 202. A single Bragg sensor solution may be sufficient for applications in which wear is measured but not misalignment of the lubricant seal to the shaft, or where the cost of associated electronics is a factor. In other embodiments, the sensor 202 includes multiple Bragg sensors. Multiple Bragg sensors can be incorporated into the sensor 202 to measure the stress at multiple points around the circumference of the lubricant seal 200. In this manner, several sensing zones may be arranged around the circumference of the seal using a single fibre. In addition, the fibre and consequently the sensors may be interrogated in a reflective mode using a pulse of light which has the advantage that only a single optical connection is required, or the optical fibre can operate in a transmission mode which would require a first and second optical connections with a corresponding light source and detector. Approximately 30 sensing zones may be placed on a single fibre each operating at a different brag frequency which allows the system to detect seal faults at different locations around its circumference.

In exemplary embodiments, the sensor 202 is able to communicate directly with a remote location, such as a server. In some embodiments, the sensor 202 provides a signal in real time to the server for maintenance management. In exemplary embodiments, the signal is communicated wirelessly, such as using Bluetooth technology. Software on the server will then be able to process the data coming from the sensor 202 in real time, facilitating maintenance of the lubricant seal 200.

In exemplary embodiments, the lubricant seal 200 has high sensitivity. In exemplary embodiments, the sensor 202 can withstand the vulcanization process used to form the lubricant seal 200. Typically, vulcanization is done at about 200° C. at 2000 pounds/inch² while the diffraction gratings are diffused into the sensor 202 at about 2000° C. In exemplary embodiments, up to fifty sensing regions are integrated into the sensor 202, allowing sensing along the circumference of the lubricant seal 200 to be obtained. While static measurements can be taken, the sensor 202 is also designed for real time or near real time dynamic measurements, in some embodiments.

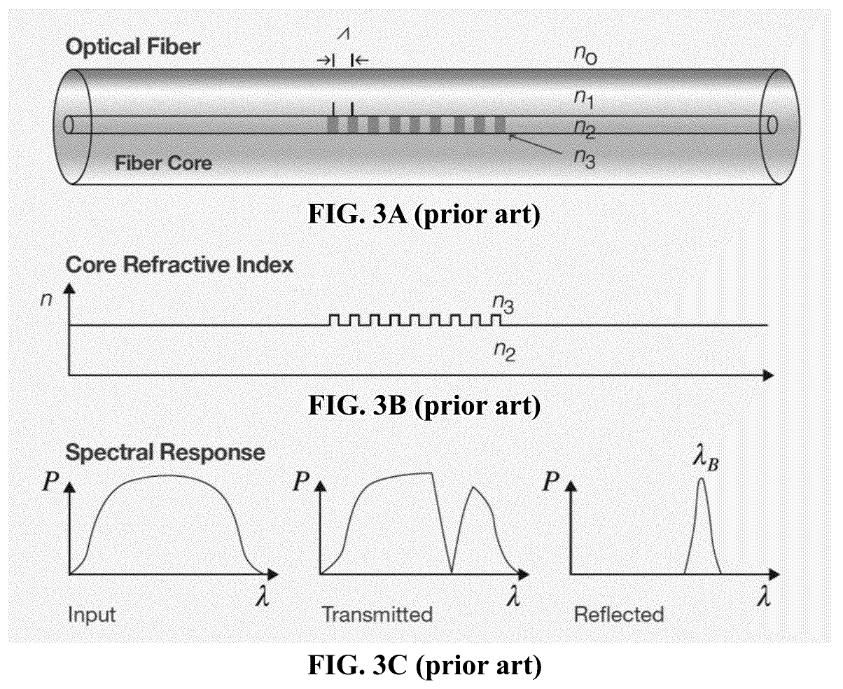

FIGS. 3A-3C are representative drawings of a fiber Bragg grating, according to the prior art. FIG. 3A shows the FBG structure; FIG. 3B shows the refractive index profile; and FIG. 3C shows the spectral response. Diffraction gratings work using incident light. A photodiode with a broad spectrum may be used to put light into the fiber of the sensor 202. There are different ways the diffraction gratings can be used. One is using the frequency of the diffraction grating. Some of the light gets deflected, which can be detected by a beam splitter and photodiode at one end of the sensor 202. Or the reflection coming back from the sensor 202 can be measured. Or the absorption can be measured by putting a photo diode at one end of the sensor fiber. A light emitting diode (LED) can be provided as the light source while the photo diode detects the light. A frequency analyzer can then be used to look at the signal coming back from each of the sensors in the fiber optic-based strain sensor 202.

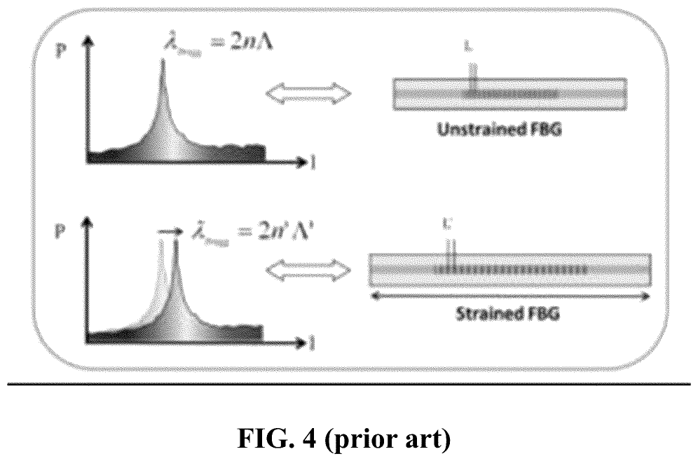

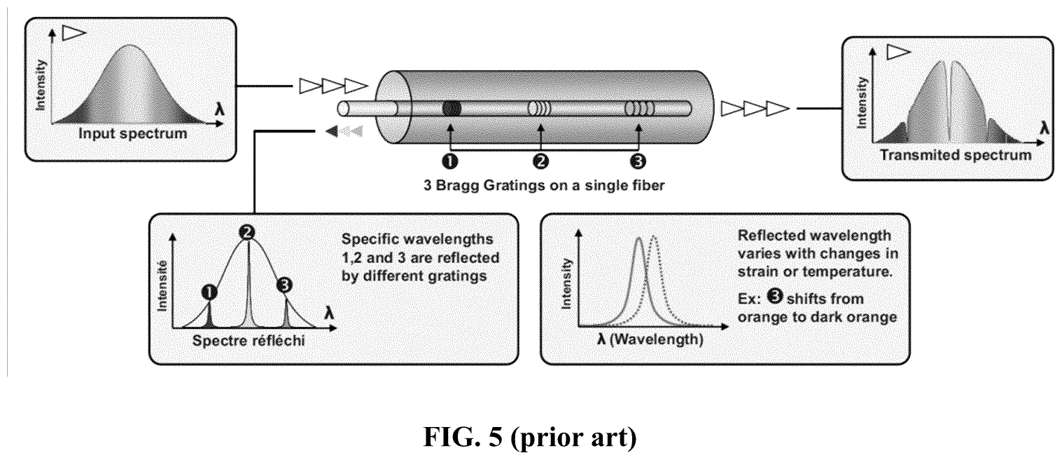

FIG. 4 is a representative drawing showing a pair of graphs that compare unstrained and strained FBG, according to the prior art. FIG. 5 is a representative drawing showing operation of Bragg gratings, according to the prior art. Three different Bragg gratings, denoted 1, 2, and 3, are located on a single fiber. Incident light is shown as an input spectrum and a transmitted spectrum is also shown. Specific wavelengths 1, 2, and 3 are reflected by different gratings. The reflected wavelength varies with changes in strain or temperature. For example, Bragg grating 3 shifts as indicated in the bottom graph on the right.

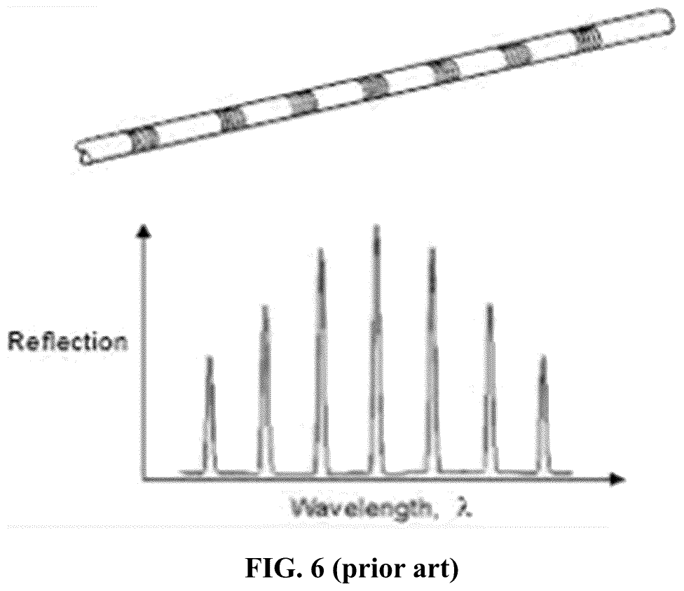

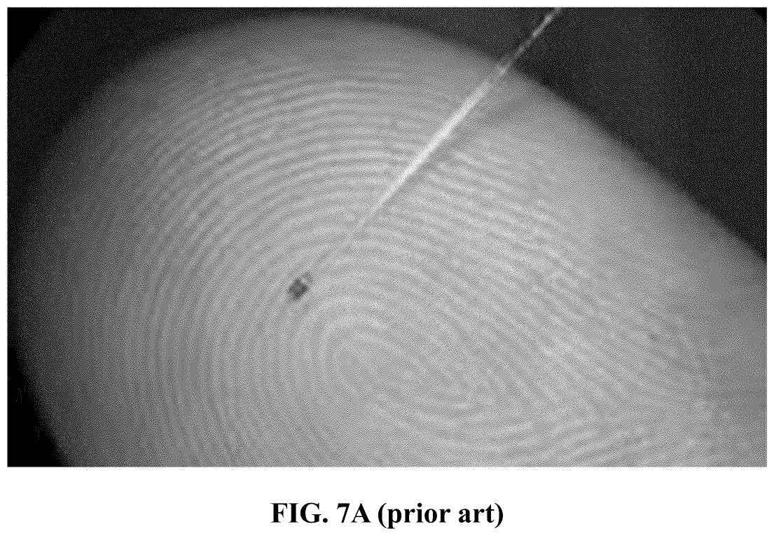

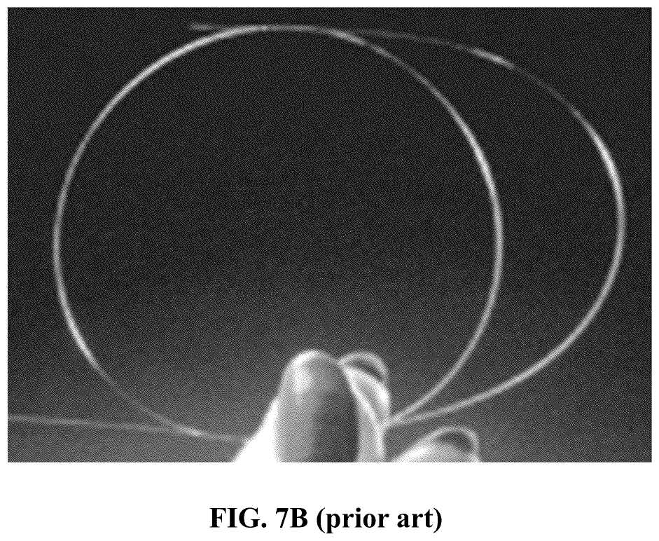

FIG. 6 is a representative drawing of a fiber Bragg grating, as well as a graph measuring wavelength versus reflection, according to the prior art. FIGS. 7A and 7B are representative photographs of fiber Bragg gratings, according to the prior art. FIG. 7A shows the FBG on a human finger while FIG. 7B shows the FBG being held. Both photographs illustrate that the FBGs are quite small.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

While the present disclosure makes reference to certain embodiments, numerous modifications, alterations and changes to the described embodiments are possible without departing from the sphere and scope of the present disclosure, as defined in the appended claim(s). Accordingly, it is intended that the present disclosure not be limited to the described embodiments, but that it has the full scope defined by the language of the following claims, and equivalents thereof.

1. A lubricant seal comprising:
a main sealing lip adapted to be disposed against a rotating shaft;
a resilient rubber material, the garter spring to maintain a pressure of the lubricant seal to the rotating shaft; and
a sensor embedded within the rubber material and disposed above a location in which the mail sealing lip touches the rotating shaft.

2. The lubricant seal of claim 1, wherein the sensor is a fiber optic-based strain sensor.

3. The lubricant seal of claim 2, wherein the sensor has regions in which Bragg diffraction gratings are diffused into the fiber optic-based strain sensor.

4. The lubricant seal of claim 1, wherein the sensor is a fiber Bragg grating (FBG).

5. The lubricant seal of claim 1, wherein the sensor senses wear of the lubricant seal.

6. The lubricant seal of claim 1, wherein the sensor senses misalignment of the shaft relative to the lubricant seal.

7. The lubricant seal of claim 1, wherein diffraction gratings in the sensor will get closer together in response to compression of the lubricant seal.

8. The lubricant seal of claim 1, wherein diffraction gratings in the sensor will move farther apart in response to stretching of the lubricant seal.

9. The lubricant seal of claim 1, wherein the sensor further comprises a first Bragg sensor to measure wear of the lubricant seal.

10. The lubricant seal of claim 9, wherein the sensor further comprises a second Bragg sensor to measure misalignment of the lubricant seal to the shaft.

11. The lubricant seal of claim 1, wherein the sensor further comprises a plurality of Bragg sensors to measure stress at multiple points around a circumference of the lubricant seal.

12. The lubricant seal of claim 1, wherein the sensor generates a signal in real time to indicate that wear of the lubricant seal or misalignment of the shaft relative to the lubricant seal.

13. The lubricant seal of claim 12, wherein the signal is generated wirelessly.

14. The lubricant seal of claim 12, wherein the signal is received by a frequency analyzer.

15. The lubricant seal of claim 4, further comprising photodiode with a broad spectrum to issue light into the fiber of the sensor.

16. The lubricant seal of claim 4, further comprising a light emitting diode to issue light into the fiber of the sensor.

17. The lubricant seal of claim 4, further comprising a beam splitter disposed at one end of the sensor, the beam splitter to sense deflected light.
